(19) United States
(12) Patent Application Publication
(10) Pub. No.: US 2002/0004150 A1
(43) Pub. Date: Jan. 10, 2002

(54) MAGNETIC RECORDING MEDIUM

(76) Inventors: YUKARI YAMADA, MIYAGI (JP); TAKAO MORI, MIYAGI (JP); HIROSHI YATAGAI, MIYAGI (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/302,322

(22) Filed: Apr. 29, 1999

(30) Foreign Application Priority Data
Apr. 30, 1998 (JP) 10-121225

(51) Int. Cl. G11B 5/725

(52) U.S. Cl. 428/694 TF

(57) ABSTRACT

A magnetic recording medium including a lubricant which is capable of maintaining adhesiveness and a lubricating characteristic regardless of conditions for use and with which the lubricating effect can be maintained for a long time so that an excellent running characteristic and satisfactory durability are realized. The magnetic recording medium includes a non-magnetic support member on which at least a magnetic layer is formed; and a lubricant held in an outermost layer of said magnetic recording medium, wherein the lubricant contains an ester compound of perfluoropolyether having a hydroxyl group at a terminal thereof and long-chain carboxylic acid and long-chain saturated fatty acid ester or an ester compound of perfluoropolyether having a carboxylic group at a terminal thereof and long-chain alcohol and long-chain saturated fatty acid ester. It is preferable that a mixture ratio of the ester compound of perfluoropolyether having a hydroxyl group at a terminal thereof and long-chain carboxylic acid or the ester compound of perfluoropolyether having a carboxylic group at a terminal thereof and long-chain alcohol and the long-chain saturated fatty acid ester is 10:90 to 90:10 in a weight ratio. It is preferable that the magnetic layer is made of a ferromagnetic thin metal film and the protective film is made of carbon.

### BACKGROUND OF THE INVENTION

1. Field of the Invention

The present invention relates to a magnetic recording medium incorporating a non-magnetic support member on which at least a magnetic layer is formed. More particularly, the present invention relates to a magnetic recording medium incorporating a specified lubricant which is held on the outermost layer thereof and exhibiting an excellent running characteristic and satisfactory durability.

2. Description of the Related Art

Hitherto, so-called coating-type magnetic recording mediums have widely been used each of which incorporates a magnetic layer. The magnetic layer is formed by applying, to a non-magnetic support member, a magnetic coating material. The magnetic coating material is at least composed of ferromagnetic powder such as magnetic oxide powder or an alloy magnetic powder, a binder such as vinyl chloride-vinyl acetate copolymer, polyester resin, urethane resin, polyurethane resin or the like and organic solvent.

On the other hand, high-density recording and long-time recording have been required in recent years. Therefore, a so-called magnetic recording medium of a ferromagnetic thin metal film type has been used. The foregoing magnetic recording medium has a magnetic layer formed by directly coating a non-magnetic support member made of polyester film or a polyimide film with a ferromagnetic magnetic metal material, such as Co, Co—Ni alloy, Co—Cr alloy, Co—O or the like. The ferromagnetic magnetic metal material is applied by plating or a vacuum thin-film forming technique (a vacuum evaporation method, a sputtering method, ion plating method or the like). The foregoing ferromagnetic thin metal film type magnetic recording medium has been put to practical use in a consumer video format (an 8 mm Hi-8 system, a DV system) or an industrial video format (DVCAM).

The ferromagnetic thin metal film type magnetic recording medium has excellent magnetic characteristics including high coercive force & high retentivity and a squareness ratio. Moreover, an excellent electromagnetic transducing characteristic in a short wave region can be realized. In addition, the thickness of the magnetic layer can considerably be reduced. Therefore, demagnetization occurring during a recording operation and thickness loss which takes place in a reproducing operation can significantly be prevented. Furthermore, a necessity of adding a binder or the like, which is a non-magnetic material, to the inside portion of the magnetic layer can be eliminated. Therefore, a packing density of the magnetic material can be raised. As described above, the ferromagnetic thin metal film type magnetic recording medium has a multiplicity of the advantages.

In general, the magnetic recording medium is subjected to a high-speed relative motion with respect to a magnetic head during a process for recording or reproducing a magnetic signal. The movement of magnetic recording medium must smoothly and stably be performed. Moreover, abrasion and damage caused from contact with the magnetic head must be prevented as much as possible.

However, the above-mentioned ferromagnetic thin metal film type magnetic recording medium realizes a considerably excellent smoothness of the surface of the magnetic layer. Therefore, a substantial area of contact is enlarged excessively to prevent an adhesion phenomenon (so-called “stick”). What is worse, the friction coefficient is enlarged. Thus, the ferromagnetic thin metal film type magnetic recording medium suffers from unsatisfactory durability and running characteristic. Thus, the foregoing problems have been required to be overcome.

Therefore, an attempt has been made such that a lubricant is applied to the magnetic layer of the above-mentioned magnetic recording medium, that is, the surface of the ferromagnetic thin metal film so as to improve the durability and the running characteristic. An organic fluorine compound has been known as an effective lubricant to achieve the above-mentioned objects. In Japanese Patent Laid-Open No. 05-194970, a magnetic recording medium has been disclosed which contains a lubricant composed of an ester compound of perfluoropolyether having a hydroxyl group at a terminal thereof and a long-chain carboxylic acid so that an excellent lubricating effect is realized regardless of conditions for use. Moreover, another magnetic recording medium has been disclosed in the foregoing disclosure which contains a lubricant composed of an ester compound of perfluoropolyether having a carboxylic group at a terminal thereof and a long chain alcohol so that an excellent lubricating effect is realized regardless of conditions for use.

To improve the durability of the ferromagnetic thin metal film type magnetic recording medium, a technique has been employed with which a carbon protective film is formed on the ferromagnetic thin metal film. The technique for forming the carbon protective film on the ferromagnetic thin metal film has been employed to manufacture a portion of the ferromagnetic thin metal film type magnetic recording mediums. The ferromagnetic thin metal film type magnetic recording mediums are those for DVC tapes having the consumer video format, DVCAM tapes having the industrial video format and AIT tapes for use in a tape streamer operation. Since the carbon protective film has been put to practical use, satisfactory durability can be obtained. Therefore, the carbon protective film is expected to usually be provided for the ferromagnetic thin metal film type magnetic recording medium in the future.

If the lubricant is employed to improve the durability and the running characteristic, the lubricant must be designed in consideration of the presence of the carbon protective film. The reason for this lies in that the adsorbing force between the lubricant and the carbon protective film is very small because the energy of the surface of the carbon protective film is smaller than that of the ferromagnetic thin metal film. In particular, each of the ester compound of perfluoropolyether having a hydroxyl group at a terminal thereof and the long-chain carboxylic acid and the ester compound having perfluoropolyether having a carboxylic group at a terminal thereof and long-chain alcohol has a great molecular weight. Therefore, only the lubricant is not allowed to uniformly exist on the carbon protective film.

### SUMMARY OF THE INVENTION

In view of the foregoing, an object of the present invention is to provide a magnetic recording medium incorporating a lubricant, which is suitable for a ferromagnetic thin metal film type magnetic recording medium having a carbon protective film formed thereon and which is able to maintain adhesiveness and a lubricating characteristic regardless of conditions for use and continue the lubricating effect for a long time, so that the running characteristic and the durability of the magnetic recording medium are improved.

To achieve the above-mentioned object, the inventors of the present invention have performed energetic investigations. As a result, the inventors have found a mixed material to serve as a lubricant suitable for a ferromagnetic thin metal film type magnetic recording medium having a carbon protective film. The mixed material is a mixture of an ester compound of a perfluoropolyether having a relatively large molecular weight and incorporating a hydroxyl group at a terminal thereof and a long-chain carboxylic acid and a long-chain saturated fatty acid ester having a relatively small molecular weight.

The inventors of the present invention have performed energetic investigations. As a result, the inventors have found a mixed material to serve as a lubricant suitable for a ferromagnetic thin metal film type magnetic recording medium having a carbon protective film. The mixed material is a mixture of an ester compound of perfluoropolyether having a relatively large molecular weight and incorporating carboxylic group at a terminal thereof and long-chain alcohol and long-chain saturated fatty acid ester having a relatively small molecular weight.

According to one aspect of the present invention, there is provided a magnetic recording medium including: a non-magnetic support member on which at least a magnetic layer is formed; and a lubricant held in an outermost layer of the magnetic recording medium, wherein the lubricant contains an ester compound of perfluoropolyether expressed by Chemical Formula 5 and having a hydroxyl group at a terminal thereof and long-chain carboxylic acid and long-chain saturated fatty acid ester expressed by Chemical Formula 6.

R₁COOCH₂—Rf₁—CH₂OCOR₁ (5)

where Rf₁ is a perfluoropolyether chain and R₁ is a hydrocarbon group or a fluorinated hydrocarbon group.

R′COOR″ (6)

where each of R′ and R″ is an alkyl group.

It is preferable that the magnetic recording medium according to the present invention has a structure that a mixture ratio of the ester compound of perfluoropolyether having the hydroxyl group at a terminal thereof and the long-chain carboxylic acid and the long-chain saturated fatty acid ester is 10:90 to 90:10 in the weight ratio.

According to another aspect of the present invention, there is provided a magnetic recording medium including: a non-magnetic support member on which at least a magnetic layer is formed; and a lubricant held in an outermost layer of the magnetic recording medium, wherein the lubricant contains an ester compound of perfluoropolyether expressed by Chemical Formula 7 and having a hydroxyl group at a terminal thereof and long-chain carboxylic acid and long-chain saturated fatty acid ester expressed by Chemical Formula 8.

R₂OOC—Rf₂—COOR₂ (7)

where Rf₂ is a perfluoropolyether chain and R₂ is a hydrocarbon group or a fluorinated hydrocarbon group.

R′COOR″ (8)

where each of R′ and R″ is an alkyl group.

It is preferable that the magnetic recording medium according to the present invention has a structure that a mixture ratio of the ester compound of perfluoropolyether having the hydroxyl group at a terminal thereof and the long-chain carboxylic acid and the long-chain saturated fatty acid ester is 10:90 to 90:10 in the weight ratio.

It is preferable that the magnetic recording medium according to the present invention has a structure that the total number of carbon atoms contained in R′ and R″ shown in Chemical Formulas 6 and 8 is 15 to 35.

It is preferable that the magnetic recording medium according to the present invention has a structure that the magnetic layer is made of a ferromagnetic thin metal film.

It is preferable that the magnetic recording medium according to the present invention has a structure that a protective film serving as an outermost layer is formed on the magnetic layer and the protective film is made of carbon.

The magnetic recording medium according to the present invention includes: a non-magnetic support member on which at least a magnetic layer is formed; and a lubricant held in an outermost layer of the magnetic recording medium, wherein the lubricant contains an ester compound of perfluoropolyether having a hydroxyl group at a terminal thereof a long-chain carboxylic acid and long-chain saturated fatty acid ester. According to another aspect of the present invention, there is provided the magnetic recording medium including: a non-magnetic support member on which at least a magnetic layer is formed; and a lubricant held in an outermost layer of the magnetic recording medium, wherein the lubricant contains an ester compound of perfluoropolyether having a carboxylic group at a terminal thereof and long-chain alcohol and a long-chain saturated fatty acid ester. The lubricant according to the present invention is able to maintain adhesiveness and a lubricating characteristic regardless of the conditions for use and continue the lubricating effect for a long time. Therefore, an excellent running characteristic and durability of the magnetic recording medium can be realized.

Other objects, features and advantages of the invention will be evident from the following detailed description of the preferred embodiments described in conjunction with the attached drawings.

### BRIEF DESCRIPTION OF THE DRAWING

FIG. 1 is a cross sectional view showing a magnetic recording medium according to the present invention;

FIG. 2 is a schematic cross sectional view showing an essential portion of the structure of a continuous-winding type vacuum evaporation apparatus; and

FIG. 3 is a schematic cross sectional view showing an essential portion of the structure of a magnetron sputtering apparatus.

### DESCRIPTION OF THE PREFERRED EMBODIMENTS

An embodiment of the present invention will now be described with reference to the drawing.

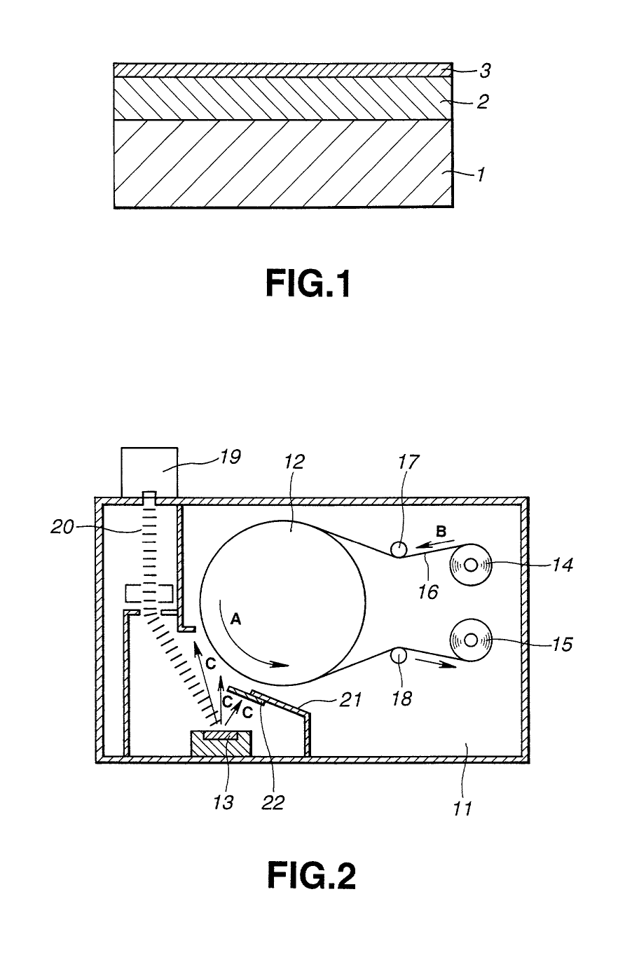

A magnetic recording medium according to the present invention has a non-magnetic support member on which at least a magnetic layer is formed. As shown in FIG. 1, the magnetic recording medium has a non-magnetic support member 1 on which a magnetic layer 2 constituted by a ferromagnetic thin metal film is formed. A protective film 3 serving as an outermost layer is formed on the magnetic layer 2.

The magnetic recording medium according to the present invention incorporates the non-magnetic support member 1 on which the ferromagnetic thin metal film is formed to serve as the magnetic layer 2. The non-magnetic support member 1 may be made of any one of the following materials: polyesters, such as polyethylene terephthalate or polyethylene naphthalate; polyolefine, such as polyethylene or polypropylene; a cellulose derivative, such as cellulose acetate or cellulose diacetate; a vinyl resin, such as polyvinyl chloride or polyvinylidene chloride; plastic resin, such as polycarbonate, polyimide, polyamide or polyamideimide; light metal, such as aluminum alloy or titanium alloy; or ceramics, such as glass. The non-magnetic support member 1 may be formed into a film, a sheet, a disc, a card or a drum.

The non-magnetic support member 1 may have a surface on which one or more types of projections, such as crest-shape projections, crease-shape projections and gain-shape projections, are formed to control the surface roughness.

The crest-shape projections are formed by injecting inorganic particles having a particle size of 50 nm to 300 nm when a polymer film is formed. The height of the crest-shape projections from the surface of the polymer film is 10 nm to 100 nm and the density is about 1×10⁴ pieces/mm² to 1×10⁵ pieces/mm². Preferred inorganic particles for forming the crest-shape projections are calcium carbonate, silica or alumina.

The crease-shape projections can be formed by applying and drying solution of a resin diluted by specific mixed solvent. The height of the crease-shape projection is 0.01 μm to 10 μm, preferably 0.03 μm to 0.5 μm. A shortest interval between the projections is 0.1 μm to 20 μm.

The crease-shape projections are formed by a resin selected from a group consisting of polyester, such as polyethylene terephthalate or polyethylene naphthalate; polyamide; polystyrol; polycarbonate; polyacrylate; polysulfone; polyvinyl chloride; polyvinylidene; polyvinyl butyral; polyphenylene oxide; and phenoxy resin. The foregoing material may be used solely or the materials may be used in a mixed form or as a copolymer. A material containing soluble solvent is a preferred material. The employed resin is dissolved in its good solvent to have a resin density of 1 ppm to 1000 ppm. Then, solvent which is bad solvent of the employed resin and which has a boiling point higher than that of the foregoing good solvent is added to the foregoing solution of the good solvent in a quantity which is 10 times to 100 times the quantity of the resin. The obtained solution is applied to the surface of the polymer film, and then the surface was dried. Thus, a thin film having a very fine crease-shape projections and pits can be formed.

The grain-shape projections are formed by allowing very small organic particles of an acrylic resin or inorganic particles, such as silica or metal powder, to adhere to the surface of the polymer film to form spherical or semispherical shapes. The heights of the grain-shape particles are 5 nm to 50 nm and the density is about 1×10⁶ pieces/mm² to 5×10⁷ pieces/mm².

When at least one or more types of the above-mentioned projections are formed, the surface characteristic of the ferromagnetic thin metal film which is the magnetic layer can be controlled. When two or more types of the projections are combined, the effect can be improved. If the crease-shape projections and the grain-shape projections are formed on the non-magnetic support member 1 having the crest-shape projections, the durability and the running characteristic can significantly be improved.

In the foregoing case, it is preferable that the heights of the overall projections satisfy a range from 10 nm to 200 nm. It is preferable that the density of the projections is 1×10⁵ pieces/mm² to 1×10⁷ pieces/mm².

The ferromagnetic thin metal film serving as the magnetic layer 2 may be made of metal, such as Fe, Co or Ni; Co—Ni alloy; Co—Pt alloy; Co—Ni—Pt alloy; Fe—Co alloy; Fe—Ni alloy; Fe—Co—Ni alloy; Fe—Co—B alloy; Co—Ni—Fe—B alloy; Co—Cr alloy; or a ferromagnetic metal material in which the foregoing material contains metal, such as Cr or Al. In particular, a vertically magnetized film can be formed when the Co—Cr alloy is employed.

The ferromagnetic thin metal film serving as the magnetic layer 2 is in the form of a continuous film by a vacuum thin-film forming technique, such as a vacuum evaporation method, an ion plating method or a sputtering method.

The vacuum evaporation method has a step of evaporating a ferromagnetic metal material by resistance heating, high-frequency heating or electron-beam heating in a vacuum of 1×10⁻² Pa to 1×10⁻⁶ Pa. Thus, the evaporated metal (the ferromagnetic metal material) is deposited to the surface of the non-magnetic support member. To obtain large coercive force, an oblique evaporation method is employed in general with which the ferromagnetic metal material is obliquely evaporated to the non-magnetic support member 1. To obtain larger coercive force, the evaporation may be formed in an oxygen atmosphere.

Also the ion plating method is one of the vacuum evaporation methods. A DC glow discharge or an RF glow discharge is caused to occur in an inert gas atmosphere, the pressure of which is 1×10⁻² Pa to 1×10⁻¹ Pa, to evaporate the foregoing magnetic metal material.

The sputtering method has the step of causing a glow discharge to occur in an atmosphere, the main component of which is argon gas, the pressure of which is 1×10⁻¹ Pa to 1×10 Pa. Then, generated argon ions are used to eject atoms in the surface of the target. The sputtering method includes a DC two-polar sputtering method, a three polar sputtering method, a high frequency sputtering method and a magnetron sputtering method using a magnetron discharge depending on the glow discharge method. When the sputtering method is employed, a base film made of Cr, W or V may previously be formed.

With any one of the foregoing methods, a base metal layer made of Bi, Sb, Pb, Sn, Ga, In, Cd, Ge, Si or Tl is previously formed by coating the support member. Then, a forming operation is performed from a vertical direction with respect to the surface of the non-magnetic support member 1. Thus, a magnetic layer free from orientation of the magnetic anisotropy and having excellent inplane isotropy can be formed. When, for example, a magnetic disc is manufactured, a satisfactory result can be obtained.

It is preferable that the thickness of the ferromagnetic thin metal film formed by the above-mentioned method is 0.01 μm to 1 μm.

It is preferable that the protective film 3 which is formed on the ferromagnetic thin metal film which serves as the magnetic layer 2 is made of carbon. In particular, it is preferable that the protective film 3 is made of diamond-like carbon having relatively high hardness. As an alternative to this, the protective film 3 may be made of SiO₂, silicon nitride, carbon nitride, ZrO₂, TiC, Al₂O₃ or the like.

The magnetic recording medium according to this embodiment incorporates the protective film 3 which is the outermost layer and which holds a lubricant containing an ester compound of perfluoropolyether expressed by the following Chemical Formula 9 and having a hydroxyl group at a terminal thereof and long-chain carboxylic acid and the long-chain saturated fatty acid ester expressed by the following Chemical Formula 10.

R₁COOCH₂—Rf₁—CH₂OCOR₁ (9)

where Rf₁ is a perfluoropolyether chain and R₁ is a hydrocarbon group or a fluorinated hydrocarbon group.

R′COOR″ (10)

where each of R′ and R″ is an alkyl group.

The ester compound of the perfluoropolyether expressed by Chemical Formula 9 and having a hydroxyl group at a terminal thereof and the long-chain carboxylic acid can easily be prepared by the following method: for example, perfluoropolyether having a hydroxyl group at a terminal thereof and carboxylic chloride are allowed to react with each other by using a base to serve as a catalyst so that the foregoing ester compound is prepared.

It is preferable that perfluoropolyether having a hydroxyl group at a terminal thereof is perfluoropolyether having hydroxyl groups at two terminals thereof. The foregoing material is exemplified by HOCH₂CF₂ (OC₂F₄)ₚ(OCF₂)_{q}OCF₂CH₂OH. As a matter of course, perfluoropolyether having a hydroxyl group at a terminal thereof is not limited to the foregoing material. Note that each of p and q shown in the Chemical Formula expressing perfluoropolyether is an integer not smaller than 1.

The molecular weight of perfluoropolyether having a hydroxyl group at a terminal thereof is not limited particularly. It is preferable that the molecular weight is about 600 to 5000 from a viewpoint of practical use. If the molecular weight is too large, the effect of the terminal group to serve as the adsorbing group is reduced. Moreover, perfluoropolyether cannot easily be dissolved in conventional hydrocarbon solvent because the perfluoropolyether chain is enlarged. If the molecular weight is too small, the lubricating effect obtainable from the perfluoropolyether chain cannot be obtained.

Perfluoropolyether having a hydroxyl group at a terminal thereof may have the perfluoropolyether chain which is partially hydrogenated. That is, a portion of fluorine atoms (50% or lower) of the perfluoropolyether chain may be replaced by hydrogen atoms. In the foregoing case, perfluoropolyether having the hydrogenated portion may be employed as perfluoropolyether.

The carboxylic acid chloride base may be either of a commercial item or a prepared material.

The long-chain carboxylic acid may have an arbitrary structure. The structure may be a branched structure, an anisotropic structure or an alicyclic structure regardless of a fact whether or not an unsaturated bond exists. Also the molecular weight may be determined arbitrarily. Since the dissolution in a usual organic solvent of a hydrocarbon type becomes difficult as the molecular weight is reduced, it is preferable that the number of carbon atoms of the alkyl group is 10 or more.

It is preferable that the long-chain saturated fatty acid ester which is contained in the lubricant has a structure that the total number of carbon atoms in the two alkyl groups is 15 to 35. Specifically, hexyl laurate (C₁₁H₂₃COOC₆H₁₃), heptyl laurate (C₁₁H₂₃COOC₇H₁₅), octyl laurate (C₁₁H₂₃COOC₈H₁₇), decyl laurate (C₁₁H₂₃COOC₁₀-H₂₁), heptyl myristate (C₁₃H₂₇COOC₇H₁₅), octyl myristate (C₁₃H₂₇COOC₈H₁₇), decyl myristate (C₁₃H₂₇COOC₁₀H₂₁), butyl palmitate (C₁₅H₃₁COOC₄H₉), heptyl palmitate (C₁₅H₃₁COOC₇H₁₅), decyl palmitate (C₁₅H₃₁COOC₁₀H₂₁), butyl stearate (C₁₇H₃₅COOC₄H₉), pentyl stearate (C₁₇H₃₁COOC₅H₁₁), heptyl stearate (C₁₇H₃₅COOC₇H₁₅), octyl stearate (C₁₇H₃₅COOC₈H₁₇) and decyl stearate (C₁₇H₃₅COOC₁₀H₂₁). If the number of carbon atoms in the fatty acid ester compound is smaller than 15, a satisfactory lubricating effect cannot be obtained. As a result, a required effect to improve the still durability cannot be obtained. If the number of carbon atoms is larger than 35, the solubility with respect to organic solvent deteriorates. It is an important fact that the fatty acid ester must be selected from the saturated fatty acid ester. The saturated fatty acid ester enables the initial lubricating characteristic to be maintained even after a long-term preservation.

It is preferable that the lubricant for use in the magnetic recording medium according to this embodiment has a structure that the mixture ratio of the ester compound of perfluoropolyether having a hydroxyl group at a terminal thereof and the long-chain carboxylic acid and the long-chain saturated fatty acid ester is 10:90 to 90:10 in the weight ratio. If the foregoing range is not satisfied, the effects of the present invention cannot easily be obtained.

The method of causing the lubricant to be held in the outermost layer of the magnetic recording medium according to this embodiment may be a method of top-coating the surface (the surface of the protective film 3) of the magnetic layer 2 or the surface of the protective film 3. It is preferable that the quantity of coating is 0.05 mg/m² to 100 mg/m², more preferably 0.1 mg/m² to 50 mg/m². If the quantity of coating is too small, satisfactory effects of reducing the friction coefficient and improving the wear resistance and the durability cannot be obtained. If the quantity of coating is too large, the sticking phenomenon occurs between the sliding member and the sliding portion. In this case, the running characteristic undesirably deteriorates.

The magnetic recording medium according to this embodiment may contain a rust preventive agent, if necessary. The rust preventive agent may be a usual rust preventive material for use as a magnetic recording medium of the foregoing type. For example, the rust preventive material may be phenol, naphthol, quinone, a heterocyclic compound containing a nitrogen atom, a heterocyclic compound containing an oxygen atom or a heterocyclic compound containing a sulfur atom.

A so-called backcoat layer may be formed on the surface of the non-magnetic support member 1 opposite to the surface of the non-magnetic support member 1 on which the magnetic layer 2 is formed. The backcoat layer is formed by a backcoating material obtained by mixing and dispersing a binding resin and a powder component in organic solvent to the non-magnetic support member.

The binding resin for forming the backcoating material is exemplified by a vinyl chloride-vinyl acetate copolymer; a vinyl chloride-vinylidene chloride copolymer; a vinyl chloride-acrylonitrile copolymer; an acrylic ester-acrylonitrile copolymer; a thermoplastic polyurethane elastomer; a vinylidene chloride-acrylonitrile copolymer; a butadiene-acrylonitrile copolymer; a polyamide resin; polyvinylbutyral; a cellulose derivative; a polyester resin; a phenol resin; an epoxy resin; a polyurethane setting resin; a melamine resin; an alkyd resin; a silicon resin; an epoxy-polyamide resin; a nitrocellulose-melamine resin; a mixed material of a polymer polyester resin and an isocyanate prepolymer; a mixed material of a mathacrylate copolymer and a di-isocyanate prepolymer; a mixed material of polyester polyol and polyisocyanate; a urea formaldehyde resin; a mixed material of low-molecular-weight glycol/high-molecular weight diol/triphenylmethanetriisocyanate; polyamine resin; and their mixtures.

To improve the dispersion characteristic of the powder component, a binding resin having a hydrophilic polar group may be employed.

The powder component may be fine carbon powder for realizing a conductivity or inorganic pigment for controlling the surface roughness and improving the durability. The fine carbon particle may be furnace carbon; channel carbon; acetylene carbon; thermal carbon or lamp carbon. The inorganic pigment is exemplified by α-FeOOH, α-Fe₂O₃, Cr₂O₃, TiO₂, ZnO, SiO, SiO₂, SiO₂.2H₂O, Al₂O₃, CaCO₃, MgCO₃ and Sb₂O₃.

The organic solvent for forming the backcoating material may be ketone-type solvent, such as acetone, methylethyl ketone, methylisobutylketone or cyclohexhane; ester-type solvent, such as methyl acetate, ethyl acetate, butyl acetate, ethyl lactate or glycol monoethylether acetate; glycolether-type solvent, such as glycoldimethylether, glycol monoethylether or dioxane; aromatic hydrocarbon type solvent, such as benzene, toluene or xylene; ariphatic hydrocarbon solvent, such as hexane or heptane; chlorinated hydrocarbon type solvent, such as methylene chloride, ethylene chloride, carbon tetrachloride, chloroform, ethylene chlorohydrin or dichlorobenzene; or a multipurpose solvent.

A lubricant may be added to the backcoat layer. In the foregoing case, the lubricant may be included in the backcoat layer or the lubricant may be applied to the surface of the backcoat layer. In either case, the lubricant may be a known lubricant, such as fatty acid, fatty acid ester, fatty acid amide, metallic soap, aliphatic alcohol or silicon lubricant.

The magnetic recording medium according to this embodiment incorporates the non-magnetic support member 1 on which at least the magnetic layer 2 is formed. Moreover, the protective film 3 which is the outermost layer of the magnetic recording medium holds the lubricant containing an ester compound of perfluoropolyether having a hydroxyl group at a terminal thereof and long-chain carboxylic acid and long-chain saturated fatty acid ester. The lubricant is able to maintain the adhesiveness and the lubricating characteristic regardless of the conditions for use and continuing the lubricating effect for a long time. Therefore, the magnetic recording medium has an excellent running characteristic and satisfactory durability.

The magnetic recording medium according to this embodiment incorporates the magnetic layer 2 in the form of a ferromagnetic thin metal film. Therefore, high-density recording and long-time recording can satisfactorily be performed. When the protective film 3 serving as the outermost layer is made of carbon, satisfactory durability can be realized.

The magnetic recording medium according to the present invention may be as follows. Another magnetic recording medium will now be described which has a substantially similar structure to that of the above-mentioned magnetic recording medium. The difference lies in only a lubricant which is held in the outermost layer. Therefore, the description will be made about only the lubricant.

That is, the magnetic recording medium according to this example incorporates the protective film 3 which serves as the outermost layer and which holds a lubricant containing an ester compound of perfluoropolyether expressed by the following Chemical Formula 11 and having a carboxylic group at a terminal thereof and long-chain alcohol and long-chain saturated fatty acid ester expressed by the following Chemical Formula 12.

R₂OOC—Rf₂—COOR₂ (11)

where Rf₂ is a perfluoropolyether chain and R₂ is a hydrocarbon group or a fluorinated hydrocarbon group.

R′COOR″ (12)

where each of R′ and R″ is an alkyl group.

The ester compound of perfluoropolyether expressed by Chemical Formula 11 and having a carboxylic group at a terminal thereof and the long-chain alcohol can easily be prepared by the following method. For example, perfluoropolyether having a carboxylic group at a terminal thereof and the long-chain alcohol are allowed to react with each other in toluene anhydride by using p-toluene sulfonate or concentrated sulfuric acid. Thus, the foregoing ester compound can be obtained.

It is preferable that perfluoropolyether having a carboxylic group at a terminal thereof has carboxylic groups at two ends thereof. The preferred material is exemplified by HOOCCF₂ (OC₂F₄)ₘ(OCF₂)ⱼOCF₂COOH. As a matter of course, perfluoropolyether having a carboxylic group at a terminal thereof is not limited to the foregoing description. Note that each of m and j shown in the chemical formula expressing perfluoropolyether is an integer not smaller than 1.

The molecular weight of perfluoropolyether having a hydroxyl group at a terminal thereof is not limited particularly. It is preferable that the molecular weight is about 600 to 5000 from a viewpoint of practical use. If the molecular weight is too large, the effect of the terminal group to serve as the adsorbing group is reduced. Moreover, perfluoropolyether cannot easily be dissolved in conventional hydrocarbon solvent because the perfluoropolyether chain is enlarged. If the molecular weight is too small, the lubricating effect obtainable from the perfluoropolyether chain cannot be obtained.

Perfluoropolyether having a hydroxyl group at a terminal thereof may have the perfluoropolyether chain which is partially hydrogenated. That is, a portion of fluorine atoms (50% or lower) of the perfluoropolyether chain may be replaced by hydrogen atoms. In the foregoing case, perfluoropolyether having the hydrogenated portion may be employed as perfluoropolyether.

The long-chain alcohol may be either of a commercial item or a prepared material. Since the dissolution in a usual organic solvent becomes difficult as the molecular weight is reduced, it is preferable that the number of carbon atoms of one alkyl group is 6 or more.

It is preferable that the long-chain saturated fatty acid ester which is contained in the lubricant has a structure that the total number of carbon atoms in the two alkyl groups is 15 to 35. Specifically, hexyl laurate (C₁₁H₂₃COOC₆H₁₃), heptyl laurate (C₁₁H₂₃COOC₇H₁₅), octyl laurate (C₁₁H₂₃COOC₈H₁₇), decyl laurate (C₁₁H₂₃COOC₁₀H₂₁), heptyl myristate (C₁₃H₂₇COOC₇H₁₅), octyl myristate (C₁₃H₂₇COOC₈H₁₇), decyl myristate (C₁₃H₂₇COOC₁₀H₂₁), butyl palmitate (C₁₅H₃₁COOC₄H₉), heptyl palmitate (C₁₅H₃₁COOC₇H₁₅), decyl palmitate (C₁₅H₃₁COOC₁₀H₂₁), butyl stearate (C₁₇H₃₅COOC₄H₉), pentyl stearate (C₁₇H₃₁COOC₅H₁₁), heptyl stearate (C₁₇H₃₅COOC₇H₁₅), octyl stearate (C₁₇H₃₅COOC₈H₁₇) and decyl stearate (C₁₇H₃₅COOC₁₀H₂₁). If the number of carbon atoms in the fatty acid ester compound is smaller than 15, a satisfactory lubricating effect cannot be obtained. As a result, a required effect to improve the still durability cannot be obtained. If the number of carbon atoms is larger than 35, the solubility with respect to organic solvent deteriorates. It is an important fact that the fatty acid ester must be selected from the saturated fatty acid ester. The saturated fatty acid ester enables the initial lubricating characteristic to be maintained even after a long-term preservation.

It is preferable that the lubricant for use in the magnetic recording medium according to this embodiment has a structure that the mixture ratio of the ester compound of perfluoropolyether having a carboxylic group at a terminal thereof and the long-chain alcohol and the long-chain saturated fatty acid ester is 10:90 to 90:10 in the weight ratio. If the foregoing range is not satisfied, the effects of the present invention cannot easily be obtained.

The method of causing the lubricant to be held in the outermost layer of the magnetic recording medium according to this embodiment may be a method of top-coating the surface (the surface of the protective film 3) of the magnetic layer 2 or the surface of the protective film 3. It is preferable that the quantity of coating is 0.05 mg/m² to 100 mg/m², more preferably 0.1 mg/m² to 50 mg/m². If the quantity of coating is too small, satisfactory effects of reducing the friction coefficient and improving the wear resistance and the durability cannot be obtained. If the quantity of coating is too large, the sticking phenomenon occurs between the sliding member and the sliding portion. In this case, the running characteristic undesirably deteriorates.

Similarly to the above-mentioned magnetic recording medium, the magnetic recording medium according to this embodiment incorporates the non-magnetic support member 1 on which at least the magnetic layer 2 is formed. Moreover, the protective film 3 serving as the outermost layer holds the lubricant containing the ester compound of perfluoropolyether having a carboxylic group at a terminal thereof and long-chain alcohol and long-chain saturated fatty acid ester. Therefore, the adhesiveness and lubricating characteristic can be maintained regardless of the conditions for use. Since the lubricating effect can be maintained for a long time, a satisfactory running characteristic and satisfactory durability of the magnetic recording medium can be realized.

The magnetic recording mediums according to the present invention can be manufactured as follows: a ferromagnetic thin metal film serving as a magnetic layer is formed on the non-magnetic support member by, for example, a vacuum evaporation method. Then, for example, a magnetron sputtering method is employed to form the protective film. Then, a predetermined lubricant is top-coated to the surface of the protective film so that the lubricant is held in the protective film. If necessary, the backcoat layer may be formed.

A vacuum evaporating apparatus for forming the magnetic layer is exemplified by a continuous-winding-type vacuum evaporating apparatus structure as shown in FIG. 2.

The vacuum evaporating apparatus is structured to perform the so-called oblique evaporating operation. The vacuum evaporating apparatus incorporates a vacuum chamber 11, the pressure in which is made to be a vacuum about 10×⁻³ Pa. The vacuum chamber 11 accommodates a cooling can 12 cooled to about −20° C. and arranged to rotate counterclockwise as indicated with an arrow A shown in the drawing and an evaporation source 13 which forms the ferromagnetic thin metal film and which is positioned to be opposite to the cooling can 12.

The vacuum chamber 11 of the vacuum evaporating apparatus accommodates a supply roll 14 arranged to be rotated counterclockwise when viewed in the drawing and a winding roll 15 arranged to be rotated counterclockwise when viewed in the drawing. A non-magnetic support member 16 is delivered from the supply roll 14 in a direction indicated with an arrow B shown in the drawing, and then moved along the cooling can 12. Then, the non-magnetic support member 16 is wound around the winding roll 15.

A roller 17 is disposed between the supply roll 14 and the cooling can 12, while a guide roller 18 is disposed between the cooling can 12 and the winding roll 15. Thus, the non-magnetic support member 16 which runs from the supply roll 14 to the cooling can 12 and from the cooling can 12 to the winding roll 15 is applied with a predetermined tension. As a result, the non-magnetic support member 16 is able to smoothly run.

The evaporation source 13 has a structure in which a ferromagnetic metal material, such as Co, is enclosed in a container, such as a crucible. Also an electron-beam generation source 19 for heating and evaporating the ferromagnetic metal material in the evaporation source 13 is provided for the vacuum evaporating apparatus. Thus, an electron beam 20 is accelerated-applied from the electron-beam generation source 19 to the ferromagnetic metal material in the evaporation source 13 to heat and evaporate the ferromagnetic metal material as indicated with an arrow C shown in the drawing. Thus, the ferromagnetic metal material is applied to the surface of the non-magnetic support member 16 which runs along the surface of the cooling can 12 positioned opposite to the evaporation source 13. As a result, a ferromagnetic thin metal film is formed on the non-magnetic support member 16.

In the vacuum evaporating apparatus, a passage preventive plate 21 is disposed between the evaporation source 13 and the cooling can 12. A shutter 22 is provided for the passage preventive plate 21 such that the position of the shutter 22 can be adjusted. Thus, particles which must be evaporated and which are made incident on the non-magnetic support member 16 at the predetermined angle are passed through the passage preventive plate 21. Thus, the ferromagnetic thin metal film can be formed by the oblique evaporating method.

When the ferromagnetic thin metal film is evaporated, it is preferable that oxygen gas is supplied to the portion adjacent to the surface of the non-magnetic support member 16 through an oxygen-gas introducing opening (not shown) so as to improve the magnetic characteristic, the durability and the weather resistance. To heat the evaporation source, a known means, for example, a resistance heating means, a high-frequency heating means or a laser heating means may be employed as an alternative to the foregoing heating means using the electron beam.

In this embodiment, the evaporating method is employed to form the ferromagnetic thin metal film made of Co. Another known thin-film forming method may be employed, for example, a vertical evaporation method or the sputtering method. The ferromagnetic thin metal film may be made of Ni, Fe or their alloy may be employed as well as Co. The thickness of the ferromagnetic thin metal film is 0.01 μm to 0.4 μm, preferable 0.1 μm to 0.2 μm.

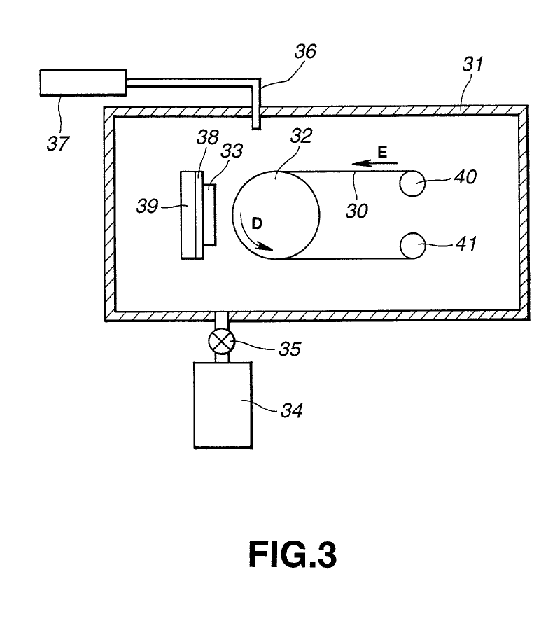

A magnetron sputtering apparatus structured as shown in FIG. 3 may be employed to form the protective film.

The magnetron sputtering apparatus shown in FIG. 3 incorporates a chamber 31 which accommodates a cooling can 32 arranged to be rotated counterclockwise as indicated with an arrow D shown in FIG. 3 and a target 33 disposed opposite to the cooling can 32.

A vacuum pump 34 for reducing the pressure in the chamber 31 is connected to the chamber 31 through a valve 35. Moreover, a gas introducing pipe 36 and a gas supply portion 37 for introducing gas into the chamber 31 are provided for the chamber 31.

Therefore, the pressure in the chamber 31 is reduced by the vacuum pump 34 to, for example, about 10⁻⁴ Pa. Then, the angle of the valve 35 for discharging air to the vacuum pump 34 is reduced from a full opening state to 10° so that the air discharge rate is reduced. On the other hand, Ar gas is introduced through the gas introducing pipe 36 so that the degree of vacuum is made to be about 0.8 Pa. Note that the cooling can 32 is cooled to, for example, about −40° C.

The target 33 is a material for forming the carbon protective film, the target 33 being supported by a bucking plate 38 which constitutes a cathode electrode. A magnet 39 for forming a magnetic field is disposed on the rear of the bucking plate 38.

A supply roll 40 arranged to be rotated counterclockwise in the drawing and a winding roll 41 arranged to be rotated counterclockwise in the drawing are disposed in the chamber 31. The cooling can 32 is discharged from the supply roll 40 in a direction indicated with an arrow E shown in the drawing, and then allowed to run along the surface of the cooling can 32 so as to be wound around the winding roll 41.

When the carbon protective film is formed by the magnetron sputtering apparatus, Ar gas is introduced through the gas introducing pipe 36. Moreover, the cooling can 32 is used to serve as an anode and the bucking plate 38 is used to serve as a cathode when a voltage of 3000 V is applied to maintain a state in which an electric current of 1.4 A is passed.

Since the foregoing voltage is applied, the Ar gas is formed into plasma so that atoms in the target 33 are sputtered. Since the magnet 39 is disposed in the rear of the bucking plate 38 and thus a magnetic field is formed adjacent to the target 33, ionized ions are concentrated to positions adjacent to the target 33.

Atoms sputtered from the target 33 are allowed to adhere to the surface of the non-magnetic support member 32 which runs around the surface of the cooling can 32 disposed opposite to the target 33 and on which the ferromagnetic thin metal film has been formed. As a result, a protective film made of carbon can be formed.

It is preferable that the thickness of the protective film is about 3 nm to about 15 nm, preferably about 5 nm to about 10 nm to reduce a spacing loss and obtain an effect of preventing abrasion of the ferromagnetic thin metal film.

In this embodiment, the protective film is formed by the magnetron sputtering method. The protective film may be formed by another known method, such as the ion beam sputtering method, an ion beam plating method or a CVD method.

### EXAMPLES

Magnetic recording mediums were manufactured to confirm the effects of the present invention by evaluating the characteristics of the magnetic recording mediums.

### Example 1

In this example, effects of the lubricant was confirmed which contained the ester compound of perfluoropolyether having a hydroxyl group at a terminal thereof and long-chain carboxylic acid and the long-chain saturated fatty acid ester.

### Manufacturing of Samples

### 1. Preparation of Ester Compound

Initially, an ester compound of perfluoropolyether having a hydroxyl group at a terminal thereof and a long-chain carboxylic acid was prepared.

Perfluoropolyether having a hydroxyl group at a terminal thereof HOCH₂CF₂ (OC₂F₄)ₚ(OCF₂)_{q}OCF₂CH₂OH (molecular weight: 2000 was used. Note that each of p and q shown in the foregoing chemical formula is an integer not smaller than 1). Then, triethylamine in a quantity which was two-times equivalent to perfluoropolyether in a molar ratio was dissolved in organic solvent. Then, chloride stearate which was two-times equivalent in a molar ratio was dripped into the foregoing solution for 30 minutes.

After the dripping operation was completed, the solution was stirred for one hour. Then, heat refluxing was performed for 30 minutes. Then, the solution was dried, and then cleaned with distilled water and water solution of diluted hydrochloric acid. Then, cleaning was again performed with distilled water until the cleaning solution was made to be neutral. Then, the organic solvent was removed, and then an obtained compound was refined by using a silica gel chromatography. As a result, an ester compound was obtained, which was called Compound 1 for convenience.

Processes similar to preparing Compound 1 were performed so that four types of Compounds 2 to 5 of perfluoropolyether having a hydroxyl group at a terminal thereof and long-chain carboxylic acid were prepared. Table 1 shows Rf₁ and R₁ shown in the following Chemical Formula 13 of perfluoropolyether having a hydroxyl group at a terminal thereof used to prepare the foregoing compounds. Also Rf₁ and R₁ shown in the following Chemical Formula 13 expressing perfluoropolyether having a hydroxyl group at a terminal thereof used to prepare Compound 1 were also shown in Table 1. Note that each of p, q and n shown in Table 1 is an integer not smaller than 1.

R₁COOCH₂—Rf₁—CH₂OCOR₁ (13)

where Rf₁ is a perfluoropolyether chain and R₁ is a hydrocarbon group or a fluorinated hydrocarbon group.

TABLE 1

| | | alkyl group | molecular |
|---|---|---|---|
| Products | perfluoropolyether chain Rf₁ | R₁ | weight |
| Compound 1 | CF₂(OC₂F₄)p(OCF₂)qOCF₂ | C₁₈H₃₇ | 2000 |
| Compound 2 | CF₂(OC₂F₄)p(OCF₂)qOCF₂ | C₁₄H₂₉ | 2000 |
| Compound 3 | F(CF₂CF₂CF₂O)nCF₂CF₂ | C₁₈H₃₇ | 3500 |
| Compound 4 | F(CF₂CF₂CF₂O)nCF₂CF₂ | C₁₄H₂₉ | 3500 |
| Compound 5 | F(CF₂CF₂CF₂O)nCF₂CF₂ | C₁₀H₂₁ | 3500 |

### 2. Manufacturing of Sample Tape

Then, magnetic tapes serving as the magnetic recording mediums were manufactured. Initially, a polyethylene terephthalate film serving as the non-magnetic support member and having a thickness of 7.0 μm was coated with Co by the oblique evaporating method by using the above-mentioned vacuum evaporating apparatus. Thus, a ferromagnetic thin metal film serving as the magnetic layer having a thickness of 180 nm was formed. Then, the foregoing magnetron sputtering apparatus was operated so that a carbon protective film serving as the protective film and having a thickness of about 8 nm was formed on the ferromagnetic thin metal film.

Then, a backcoat layer made of carbon and a polyurethane resin and having a thickness of 0.5 μm was formed on the surface of the polyethylene terephthalate film opposite to the surface of the same on which the ferromagnetic thin metal film was formed.

Thus, the non-magnetic support member was formed which had one of the main surfaces on which the ferromagnetic thin metal film and the carbon protective film were formed and another main surface on which the backcoat layer was formed. Then, materials in each of which each compound shown in the following Table 2 was dissolved in hexane solvent was applied to the surface of the carbon protective film of the non-magnetic support member such that the quantity of coating was 5 mg/m². Thus, 13 types of magnetic recording mediums were obtained. Then, 13 types of the magnetic recording mediums were cut to each have a width of 6.35 mm. As a result, sample tapes according to Examples 1 to 8 and Comparative Examples 1 to 5 were manufactured.

TABLE 2

| Sample Tape | Lubricant |
|---|---|
| Example 1 | Compound 1 + octyl myristate (weight ratio: 1:1) |
| Example 2 | Compound 1 + heptyl stearate (weight ratio: 1:1) |
| Example 3 | Compound 2 + octyl palmitate (weight ratio: 1:1) |
| Example 4 | Compound 2 + decyl laurate (weight ratio: 1:1) |
| Example 5 | Compound 3 + decyl myristate (weight ratio: 1:1) |
| Example 6 | Compound 3 + pentyl stearate (weight ratio: 1:1) |
| Example 7 | Compound 4 + decyl palmitate (weight ratio: 1:1) |
| Example 8 | Compound 5 + butyl stearate (weight ratio: 1:1) |
| Comparative | Compound 1 only |
| Example 1 | |
| Comparative | Compound 3 only |
| Example 2 | |
| Comparative | Compound 1 + octyl oleate (weight ratio: 1:1) |
| Example 3 | |
| Comparative | Compound 1 + decyl linoleate (weight ratio: 1:1) |
| Example 4 | |
| Comparative | Compound 3 + octyl linolenate (weight ratio: 1:1) |
| Example 5 | |

### 3. Evaluation of Characteristics

Then, the characteristics of the sample tapes according to Examples 1 to 8 and Comparative Examples 1 to 5 were evaluated. In this embodiment, the durability and the running characteristic were evaluated. Specifically, the friction coefficient, the still durability and the shuttle durability were evaluated. The evaluation was performed in an environment determined by the inventors of the present invention to most severe environment.

### (1) Method of Measuring Friction Coefficient

The friction coefficient was measured such that the environment in a thermostatic chamber was controlled such that the temperature was 40° C. and the humidity was 80%RH. In the thermostatic chamber, each sample tape was allowed to run 100 times so that the friction coefficient was measured. Note that the result at the 100-th run was made to be the friction coefficient.

### (2) Method of Evaluating Still Durability

The still durability was performed in a thermostatic chamber set to −5° C. A commercial digital video camcoder (“VX 1000” manufactured by SONY) was operated to measure time taken for the reproduction output from each sample tape to be reduced by 3 dB so that the still durability was evaluated.

### (3) Method of Evaluating Shuttle Durability

The shuttle durability was performed such that the environment of the thermostatic chamber was set such that the temperature was 40° C. and the humidity was 20%RH. In the foregoing thermostatic chamber, the commercial digital video camcoder (“VX 1000” manufactured by SONY) was operated to allow each sample tape to run in a shuttle running manner. Then, an amount (dB) of reduction in the reproduction output from the initial output after the sample tape was allowed to run 100 times was measured and the shuttle durability was evaluated.

The above-mentioned evaluations were performed immediately after the lubricant was applied and after each sample tape was allowed to stand at a temperature of 45° C. and a humidity of 80%RH for one month. Results of evaluations of the initial durability and running characteristic immediately after the lubricant was applied are shown in Table 3. The durability and the running characteristic after preservation for one month are shown in Table 4.

TABLE 3

| | Friction | Still Durability | Shuttle |
|---|---|---|---|
| | Coefficient | (minute) | Durability (dB) |
| | (40° C., 80% RH) | (−5° C.) | (40° C., 20% RH) |
| Example 1 | 0.24 | >180 | −1.0 |
| Example 2 | 0.22 | >180 | −0.8 |
| Example 3 | 0.26 | >180 | −0.9 |
| Example 4 | 0.23 | >180 | −1.2 |
| Example 5 | 0.25 | >180 | −1.0 |
| Example 6 | 0.22 | >180 | −0.9 |
| Example 7 | 0.26 | >180 | −1.3 |
| Example 8 | 0.22 | >180 | −1.4 |
| Comparative | 0.25 | >180 | −3.5 |
| Example 1 | | | |
| Comparative | 0.26 | >180 | −3.8 |
| Example 2 | | | |
| Comparative | 0.29 | >180 | −1.6 |
| Example 3 | | | |
| Comparative | 0.27 | >180 | −1.3 |
| Example 4 | | | |
| Comparative | 0.29 | >180 | −1.5 |
| Example 5 | | | |

TABLE 4

| | Friction | Still Durability | Shuttle |
|---|---|---|---|
| | Coefficient | (minute) | Durability (dB) |
| | (40° C., 80% RH) | (−5° C.) | (40° C., 20% RH) |
| Example 1 | 0.25 | >180 | −1.2 |
| Example 2 | 0.24 | >180 | −0.8 |
| Example 3 | 0.26 | >180 | −1.0 |
| Example 4 | 0.24 | >180 | −1.5 |
| Example 5 | 0.26 | >180 | −0.8 |
| Example 6 | 0.24 | >180 | −1.2 |
| Example 7 | 0.25 | >180 | −1.0 |
| Example 8 | 0.24 | >180 | −1.3 |
| Comparative | 0.28 | 160 | −3.7 |
| Example 1 | | | |
| Comparative | 0.28 | 130 | −4.0 |
| Example 2 | | | |
| Comparative | 0.41 | 50 | −7.5 |
| Example 3 | | | |
| Comparative | 0.43 | 30 | −6.9 |
| Example 4 | | | |
| Comparative | 0.51 | 30 | −5.7 |
| Example 5 | | | |

As can be understood from the results shown in Tables 3 and 4, Examples 1 to 8 incorporating the lubricant obtained by combining the ester compound of perfluoropolyether having a hydroxyl group at a terminal thereof and the long-chain carboxylic acid and the long-chain saturated fatty acid ester resulted in excellent results. That is, the friction coefficient, the still durability and the shuttle durability did not deteriorate in a variety of conditions for use, such as high temperature and high humidity, high temperature and low humidity and low temperature.

On the other hand, Comparative Examples 1 to 5 incorporated the lubricant containing only the ester compound of perfluoropolyether having a hydroxyl group at a terminal thereof and the long-chain carboxylic acid or the lubricant obtained by combining the ester compound of perfluoropolyether having a hydroxyl group at a terminal thereof and the long-chain carboxylic acid and unsaturated fatty acid ester. Comparative Examples 1 to 5 encountered excessive deterioration in the friction coefficient, the still durability and the shuttle durability in the variety of the conditions for use, such as high temperature and high humidity, high temperature and low humidity and low temperature. Therefore, satisfactory results were not obtained.

As a result, a fact was confirmed that use of the long-chain saturated fatty acid ester enables the initial characteristics to be maintained even after preservation for a long time.

That is, the present invention incorporates the lubricant containing the ester compound of perfluoropolyether having a hydroxyl group at a terminal thereof and long-chain carboxylic acid and the long-chain saturated fatty acid ester is held in the outermost layer. Thus, the adhesiveness and lubricating characteristic can be maintained regardless of the condition for use of the lubricant. Moreover, the lubricating effect can be maintained for a long time. As a result, an excellent running characteristic and satisfactory durability of the magnetic recording medium can be maintained.

### Example 2

In this example, effects of the lubricant were confirmed which contained the ester compound of perfluoropolyether having a carboxylic group at a terminal thereof and long-chain alcohol and the long-chain saturated fatty acid ester.

### Manufacturing of Samples

### 1. Preparation of Ester Compound

Initially, an ester compound of perfluoropolyether having a carboxylic group at a terminal thereof and a long-chain alcohol was prepared.

Perfluoropolyether having a carboxylic group at a terminal thereof HOOCCF₂(OC₂F₄)ₘ(OCF₂)ⱼOCF₂COOH (molecular weight: 2000 was used. Note that each m and j shown in the foregoing chemical formula is an integer not smaller than 1). Then, stearyl alcohol which was two-times equivalent to perfluoropolyether in a molar ratio was heat-refluxed in toluene anhydride by using p-toluene sulfonic acid in a small quantity and concentrated sulphuric acid as catalysts. The foregoing process was performed while refined water was being removed. After reactions were completed, toluene was removed. Then, an obtained compound was refined by using a silica gel chromatography. As a result, an ester compound was obtained, which was called Compound 6 for convenience.

Processes similar to preparing Compound 6 were performed so that four types of Compounds 7 to 10 of perfluoropolyether having a carboxylic group at a terminal thereof and long-chain alcohol were prepared. Table 5 shows Rf₂ and R₂ shown in the following Chemical Formula 14 of perfluoropolyether having a carboxylic group at a terminal thereof used to prepare the foregoing compounds. Also Rf₂ and R₂ shown in the following Chemical Formula 14 expressing perfluoropolyether having a carboxylic group at a terminal thereof used to prepare Compound 6 were also shown in Table 1. Note that each of j, k and m shown in Table 5 is an integer not smaller than 1.

R₂OOC—Rf₂—COOR₂ (14)

where Rf₂ is a perfluoropolyether chain and R₂ is a hydrocarbon group or a fluorinated hydrocarbon group.

TABLE 5

| | | alkyl group | molecular |
|---|---|---|---|
| Products | perfluoropolyether chain Rf₂ | R₂ | weight |
| Compound 6 | CF₂(OC₂F₄)m(OCF₂)jOCF₂ | C₁₈H₃₇ | 2000 |
| Compound 7 | CF₂(OC₂F₄)m(OCF₂)jOCF₂ | C₁₄H₂₉ | 2000 |
| Compound 8 | CF₂(OC₂F₄)m(OCF₂)jOCF₂ | C₁₂H₂₅ | 2000 |
| Compound 9 | F(CF₂CF₂CF₂O)kCF₂CF₂ | C₁₈H₃₇ | 3500 |
| Compound 10 | F(CF₂CF₂CF₂O)kCF₂CF₂ | C₁₂H₂₅ | 3500 |

### 2. Manufacturing of Sample Tape

Then, magnetic tapes serving as the magnetic recording mediums were manufactured. Similarly to Example 1, a ferromagnetic thin metal film serving as the magnetic layer and a carbon protective film serving as the protective film were formed on the non-magnetic support member. Also the backcoat layer was formed.

Then, similarly to Example 1, the surface of the carbon protective film was coated with a material in which each of compounds shown in Table 6 was dissolved in hexane solvent such that the quantity of coating was 5 mg/m². Thus, 13 types of magnetic recording mediums were obtained. Then, 13 types of the magnetic recording mediums were cut to each have a width of 6.35 mm. As a result, sample tapes according to Examples 9 to 16 and Comparative Examples 6 to 10 were manufactured.

TABLE 6

| Sample Tape | Lubricant |
|---|---|
| Example 9 | Compound 6 + octyl myristate (weight ratio: 1:1) |
| Example 10 | Compound 6 + heptyl stearate (weight ratio: 1:1) |
| Example 11 | Compound 7 + octyl palmitate (weight ratio: 1:1) |
| Example 12 | Compound 7 + decyl laurate (weight ratio: 1:1) |
| Example 13 | Compound 8 + decyl myristate (weight ratio: 1:1) |
| Example 14 | Compound 8 + pentyl stearate (weight ratio: 1:1) |
| Example 15 | Compound 9 + decyl palmitate (weight ratio: 1:1) |
| Example 16 | Compound 10 + butyl stearate (weight ratio: 1:1) |
| Comparative | Compound 6 only |
| Example 6 | |
| Comparative | Compound 8 only |
| Example 7 | |
| Comparative | Compound 6 + octyl oleate (weight ratio: 1:1) |
| Example 8 | |
| Comparative | Compound 6 + decyl linoleate (weight ratio: 1:1) |
| Example 9 | |
| Comparative | Compound 8 + octyl linolenate (weight ratio: 1:1) |
| Example 10 | |

### 3. Evaluation of Characteristics

Then, the characteristics of the sample tapes according to Examples 9 to 16 and Comparative Examples 6 to 10 were evaluated. In this embodiment, the durability and the running characteristic were evaluated. Specifically, the friction coefficient, the still durability and the shuttle durability were evaluated similarly to Example 1.

The above-mentioned evaluations were performed similarly to Example 1 immediately after application of the lubricant and after each sample tape was allowed to stand at a temperature of 45° C. and a humidity of 80%RH for one month. Results of evaluations of the initial durability and running characteristic immediately after the lubricant was applied are shown in Table 7. The durability and the running characteristic after preservation for one month are shown in Table 8.

TABLE 7

| | Friction | Still Durability | Shuttle |
|---|---|---|---|
| | Coefficient | (minute) | Durability (dB) |
| | (40° C., 80% RH) | (−5° C.) | (40° C., 20% RH) |
| Example 9 | 0.22 | >180 | −0.5 |
| Example 10 | 0.23 | >180 | −0.7 |
| Example 11 | 0.23 | >180 | −0.7 |
| Example 12 | 0.24 | >180 | −0.6 |
| Example 13 | 0.24 | >180 | −0.8 |
| Example 14 | 0.23 | >180 | −0.9 |
| Example 15 | 0.23 | >180 | −0.7 |
| Example 16 | 0.22 | >180 | −0.5 |
| Comparative | 0.22 | >180 | −1.2 |
| Example 6 | | | |
| Comparative | 0.24 | >180 | −1.3 |
| Example 7 | | | |
| Comparative | 0.24 | >180 | −1.0 |
| Example 8 | | | |
| Comparative | 0.24 | >180 | −1.1 |
| Example 9 | | | |
| Comparative | 0.25 | >180 | −1.2 |
| Example 10 | | | |

TABLE 8

| | Friction | Still Durability | Shuttle |
|---|---|---|---|
| | Coefficient | (minute) | Durability (dB) |
| | (40° C., 80% RH) | (−5° C.) | (40° C., 20% RH) |
| Example 9 | 0.24 | >180 | −0.7 |
| Example 10 | 0.24 | >180 | −0.8 |
| Example 11 | 0.25 | >180 | −1.0 |
| Example 12 | 0.26 | >180 | −0.7 |
| Example 13 | 0.26 | >180 | −0.6 |
| Example 14 | 0.23 | >180 | −0.8 |
| Example 15 | 0.24 | >180 | −0.9 |
| Example 16 | 0.24 | >180 | −1.0 |
| Comparative | 0.23 | 110 | −3.8 |
| Example 6 | | | |
| Comparative | 0.25 | 100 | −4.2 |
| Example 7 | | | |
| Comparative | 0.33 | 55 | −5.9 |
| Example 8 | | | |
| Comparative | 0.44 | 25 | −6.5 |
| Example 9 | | | |
| Comparative | 0.47 | 20 | −7.3 |
| Example 10 | | | |

As can be understood from the results shown in Tables 7 and 8, Examples 9 to 16 incorporating the lubricant obtained by combining the ester compound of perfluoropolyether having a carboxylic group at a terminal thereof and the long-chain alcohol and the long-chain saturated fatty acid ester resulted in excellent results. That is, the friction coefficient, the still durability and the shuttle durability did not deteriorate in a variety of conditions for use, such as high temperature and humidity, high temperature and low humidity and low temperature.

On the other hand, Comparative Examples 6 to 10 incorporated the lubricant containing only the ester compound of perfluoropolyether having a carboxylic group at a terminal thereof and the long-chain alcohol or the lubricant obtained by combining the ester compound of perfluoropolyether having a carboxylic group at a terminal thereof and the long-chain alcohol and unsaturated fatty acid ester. Comparative Examples 6 to 10 encountered excessive deterioration in the friction coefficient, the still durability and the shuttle durability in the variety of the conditions for use, such as high temperature and humidity, high temperature and low humidity and low temperature. Therefore, satisfactory results were not obtained.

As a result, a fact was confirmed that use of the long-chain saturated fatty acid ester enables the initial characteristics to be maintained even after preservation for a long time.

That is, the present invention incorporates the lubricant containing the ester compound of perfluoropolyether having a carboxylic group at a terminal thereof and long-chain alcohol and the long-chain saturated fatty acid ester is held in the outermost layer. Thus, the adhesiveness and lubricating characteristic can be maintained regardless of the condition for use of the lubricant. Moreover, the lubricating effect can be maintained for a long time. As a result, an excellent running characteristic and satisfactory durability of the magnetic recording medium can be maintained.

As described above, the magnetic recording medium according to the present invention incorporates the non-magnetic support member on which at least the magnetic layer is formed, wherein the outermost layer holds the lubricant containing the ester compound of perfluoropolyether having a hydroxyl group at a terminal thereof and long-chain carboxylic acid and long-chain saturated fatty acid ester or the lubricant containing the ester compound of perfluoropolyether having a carboxylic group at a terminal thereof and the long-chain alcohol and the long-chain saturated fatty acid ester. The foregoing lubricant is able to maintain the adhesiveness and the lubricating characteristic regardless of the conditions for use. Moreover, the lubricating effect can be maintained for a long time. Therefore, the excellent running characteristic and satisfactory durability of the magnetic recording medium can be maintained.

When the magnetic recording medium according to the present invention incorporates the magnetic layer made of the ferromagnetic thin metal film, long time recording can satisfactorily be performed. When the carbon protective film is formed to form the outermost layer, satisfactory durability can be realized.

Although the invention has been described in its preferred form and structure with a certain degree of particularity, it is understood that the present disclosure of the preferred form can be changed in the details of construction and in the combination and arrangement of parts without departing from the spirit and the scope of the invention as hereinafter claimed.

What is claimed is:

1. A magnetic recording medium comprising:
a non-magnetic support member on which at least a magnetic layer is formed; and
a lubricant held in an outermost layer of said magnetic recording medium, wherein
said lubricant contains an ester compound of perfluoropolyether expressed by Chemical Formula 1 and having a hydroxyl group at a terminal thereof and long-chain carboxylic acid and long-chain saturated fatty acid ester expressed by Chemical Formula 2.
R₁COOCH₂—Rf₁—CH₂OCOR₁ (1)
where Rf₁ is a perfluoropolyether chain and R₁ is a hydrocarbon group or a fluorinated hydrocarbon group,
R′COOR″ (2)
where each of R′ and R″ is an alkyl group.

2. A magnetic recording medium according to claim 1, wherein a mixture ratio of the ester compound of perfluoropolyether having a hydroxyl group at a terminal thereof and long-chain carboxylic acid and the long-chain saturated fatty acid ester is 10:90 to 90:10 in a weight ratio.

3. A magnetic recording medium according to claim 1, wherein the total number of carbon atoms contained in R′ and R″ shown in Chemical Formula 2 is 15 to 35.

4. A magnetic recording medium according to claim 1, wherein said magnetic layer is a ferromagnetic thin metal film.

5. A magnetic recording medium according to claim 1, wherein a protective film serving as an outermost layer is formed on said magnetic layer.

6. A magnetic recording medium according to claim 5, wherein said protective film is made of carbon.

7. A magnetic recording medium comprising:
a non-magnetic support member on which at least a magnetic layer is formed; and
a lubricant held in an outermost layer of the magnetic recording medium, wherein
the lubricant contains an ester compound of perfluoropolyether expressed by Chemical Formula 3 and having a carboxylic group at a terminal thereof and long-chain alcohol and long-chain saturated fatty acid ester expressed by Chemical Formula 4.
R₂OOC—Rf₂—COOR₂ (3)
where Rf₂ is a perfluoropolyether chain and R₂ is a hydrocarbon group or a fluorinated hydrocarbon group.
R′COOR″ (4)
where each of R′ and R″ is an alkyl group.

8. A magnetic recording medium according to claim 7, wherein a mixture ratio of the ester compound of perfluoropolyether having a carboxylic group at a terminal thereof and long-chain alcohol and the long-chain saturated fatty acid ester is 10:90 to 90:10 in a weight ratio.

9. A magnetic recording medium according to claim 7, wherein the total number of carbon atoms contained in R′ and R″ shown in Chemical Formula 4 is 15 to 35.

10. A magnetic recording medium according to claim 7, wherein said magnetic layer is a ferromagnetic thin metal film.

11. A magnetic recording medium according to claim 7, wherein a protective film serving as an outermost layer is formed on said magnetic layer.

12. A magnetic recording medium according to claim 11, wherein said protective film is made of carbon.
